(19) United States
(12) Patent Application Publication
(10) Pub. No.: US 2002/0144948 A1
(43) Pub. Date: Oct. 10, 2002

(54) Process for depleting monovalent cations from a water intended for nutritional purposes

(76) Inventors: Pierre Aimar, Toulouse (FR); Patrice Bacchin, Gargas (FR); Catherine Bramaud, Bordeaux (FR); Henri Jauffret, Antony (FR); Christine Raphanel, Clermon-Ferrand (FR)

Correspondence Address: Anthony C. Tridico, Finnegan, Henderson, Farabow,, Garrett & Dunner, L.L.P., 1300 I Street, N.W., Washington, DC, 20005, US

(21) Appl. No.: 10/021,498

(22) Filed: Dec. 19, 2001

(30) Foreign Application Priority Data
Dec. 20, 2000 (FR) 0016645

(51) Int. Cl. B01D 61/04

(52) U.S. Cl. 210/652; 210/669; 210/748

(57) ABSTRACT

A process for depleting monovalent cations from water comprising subjecting the water to reverse osmosis, so that the retentate from this reverse osmosis has a higher ionic concentration, and subjecting said retentate to electrodialysis, so as to recover a water depleted in monovalent cations. The water may, for example, be intended for nutritional purposes. The may also, for example, contain monovalent and divalent cations, In one embodiment, the permeate from the reverse osmosis is added to the water depleted in monovalent cations, so as to obtain a water with a controlled mineral content.

This application claims the benefit of foreign priority under 35 U.S.C. §119 of French patent application no. 0016645, filed on Dec. 20, 2000 the contents of which are incorporated by reference herein.

The invention relates to a process for depleting monovalent cations from water, for example natural waters which comprise variable contents of sodium, depending upon their origin. In one embodiment, the monovalent cations are sodium cations. In a further embodiment, the water is water that is intended for nutritional purposes,

The process according to the present invention, in one embodiment, is intended to produce sodium-free drinking waters. The term “sodium-free,” as used herein, is used in both the United States and Canada for waters comprising less than 20 mg/l of sodium. These waters are intended for individuals who, for medical reasons, wish to restrict their consumption of sodium. It is therefore in this context that a treatment process has been sought which makes it possible to deplete, in sodium, natural waters comprising more than 20 mg/l and less than 150 mg/l of sodium. Of course, the invention herein is not restricted to this context but applies generally to all water, and in one embodiment, water intended for nutritional purposes. As used herein, depleted in monovalent cations refers to water in which monovalent cations have been removed. For example, in one embodiment, a water depleted in monovalent cations comprises less than about 20 mg/l of monovalent cations such as sodium.

It is demonstrated herein that the combination of two known processes, reverse osmosis used under standard pressure conditions, for example ranging from about 0.2 to about 5 MPa, and electrodialysis, makes it possible to obtain water depleted in monovalent cations, such as sodium-free water, that may, for example, be intended for nutritional purposes. In one embodiment, the water depleted in monovalent cations is obtained without detrimentally affecting, to a significant extent, the content of divalent cations (such as in particular the Ca2+ and Mg2+ cations), which may have a health benefit.

Reverse osmosis is a known process for liquid-phase separation which makes it possible to remove a solvent from a solution by selective permeation through a membrane under the action of a pressure gradient. The stream of water moves from the solution which is concentrated in ions to the dilute solution. The flow of the fluid to be treated is continuous and tangential. The solution to be treated is divided into two parts with different concentrations:

a part which passes through the membrane and which is known as the permeate (solution with a very low concentration of ions)

a part which does not pass through the membrane and which is known as the retentate and which comprises the ions retained by the membrane. The commonest application of reverse osmosis is the demineralization of water.

Electrodialysis, for its part, is a membrane process in which the transfer force is a difference in electrical potential. The membranes involved are usually dense organic membranes known as ion-exchange membranes. These membranes, composed of organic polymers, are ionic conductors possessing a selective permeability: cation-exchange membrane (CEM) and anion-exchange membrane (AEM). The selectivity depends on the polymeric structure, on the chemical nature of the membrane material, on the steric hindrance and on the charge of the hydrated ions. The electrodes do not participate directly in the process. Their sole role is to provide for the application of the electric transfer force.

The combination of a high-pressure reverse osmosis with an electrodialysis has already been envisaged in a process which may make possible the treatment of seawater, which has a very high load of inorganic salts (composition: 3.3% of dissolved salts (i.e. 33 g/l), including 0.193% by weight (1.93 g/l) of MgSO4, 0.327% by weight (3.27 g/l) of MgCl2, 0.132% by weight (1.32 g/l) of CaSO4, 0.010% by weight (0.10 g/l) of MgBr2, 0.011% by weight (0.11 g/l) of CaCO3, 1.02% by weight (10.2 g/l) of Na+, 1.85% by weight (18.5 g/l) of Cl− and 0.0371% by weight (0.371 g/l) of K+). (Ohya et al., Nippon Kaisui Gakkaishi, 1995, vol. 49(4), page 195-201). The combination of these two processes may additionally make it possible to separate the monovalent ions from the divalent ions with the aim of preventing the precipitation of the salts of divalent cations and thus of increasing the yield of the demineralization process.

However, the authors recognize that such a process still cannot be carried out currently given that the reverse osmosis stage is carried out at a very high pressure (of the order of several tens of MPa) and that membranes which withstand such a pressure still do not exist.

Furthermore, the water to be treated in this process has a very high load (seawater), in contrast to the water to be treated in the present invention. The concentration range of the process described in this document is therefore very different from that of the present invention. For example, in the reverse osmosis retentate, the concentration of salt from seawater may even reach a concentration 4 to 5 times greater, that is to say a value close to 21% by weight (210 g/l).

Thus, there currently does not exist a process for selectively depleting monovalent cations from water, such as, for example water intended for nutritional purposes.

The Inventors have found, in one embodiment, a surprisingly significant selectivity between monovalent cations and divalent cations by the use of the process according to the present invention. The Inventors have also found that the selectivity of the electrodialysis stage between the monovalent cations and the divalent cations may increase in proportion as the ionic concentration of the water to be treated increases.

Thus, in one embodiment, when the electrodialysis is preceded by a stage of reverse osmosis at standard pressure, and in particular when the reverse osmosis retentate is subsequently treated by electrodialysis, the water is selectively depleted in monovalent cations, whereas the content of divalent ions (for example Ca2+ and Mg2+), ions, is not detrimentally affected to any significant extent.

The present invention thus, in one embodiment, relates to a process for depleting monovalent cations from water comprising subjecting the water to a reverse osmosis, so that the retentate from this reverse osmosis has a higher ionic concentration, and subjecting said retentate to electrodialysis, so as to recover a water depleted in monovalent cations. In a further embodiment, the water is water intended for nutritional purposes, such as, for example, water comprising monovalent and divalent cations. In another embodiment, the process makes it possible to obtain water retaining most of its divalent cations with a water yield of about 100%.

In another embodiment, the permeate from the reverse osmosis is readded to the water depleted in monovalent cations, so as to obtain a water with a controlled mineral content. The term “water with a controlled mineral content” is understood to mean, within the meaning of the present invention, any water for which the amount of ions present therein can be adjusted according to requirements using the operating conditions of the process.

For example, the membrane surface areas employed in the electrodialysis may be adjusted according to the objectives of water yield and of maximum loss of divalent cations. The higher the water yield, the greater the loss of divalent cations. In one embodiment, the water yield is about 100% and the yield of divalent cations is at least about 65%. The content of divalent cations, ions having a proven health benefit, is therefore not significantly modified.

In a further embodiment, the water before treatment comprises at most approximately 3 g/l of total ions, such as for example, water intended for nutritional purposes. The cations commonly present in this type of water are the usual cations, such as monovalent potassium and sodium cations (respectively K+ and Na+), divalent calcium and magnesium cations (respectively Ca2+ and Mg2+) and hydrogencarbonate, chloride and sulfate anions. Of course, this list is not exhaustive and other ions may be present, for example, possibly in the trace form.

In a specific embodiment of the invention, the sodium content of the water before treatment ranges from about 20 to about 150 mg/l of sodium. In one embodiment, the water depleted in monovalent cations has a sodium content less than or equal to about 20 mg/l of sodium.

In another advantageous embodiment, the pressure of the reverse osmosis is less than about 10 MPa, such as, for example, ranging from 0.2 MPa to 5 MPa.

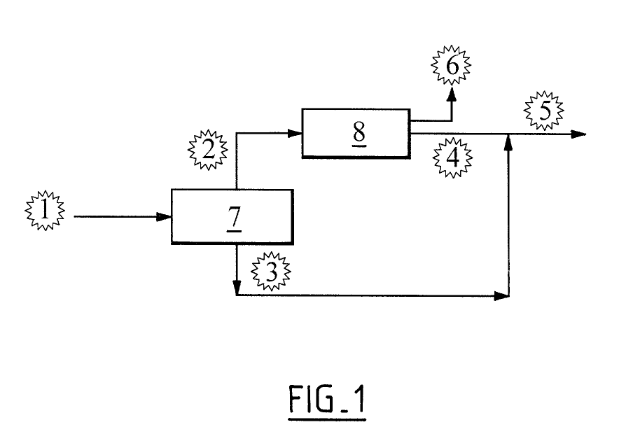

FIG. 1 represents the diagram of a specific embodiment of the process according to the invention.

The following examples are given by way of indication and without implied limitation.

### EXAMPLES

Procedure

Use is made of the process according to the diagram represented by FIG. 1. The water intended for nutritional purposes (1) is subjected to a reverse osmosis (7). The reverse osmosis retentate (2) is subjected to an electrodialysis (8), so as to obtain a solution which is highly concentrated in monovalent cations (6) and a solution which is depleted in monovalent ions (4). The reverse osmosis permeate (3) is subsequently reincorporated at the electrodialysis outlet (7) in this solution (4), in order to adjust the ionic concentration of the final water (5) and to obtain a good water yield. The pressure of the reverse osmosis is 0.5 MPa. The membrane surface area involved in the reverse osmosis is 53 m2.

Results

The water flow rate and the concentrations (in mg/l) of Na+, K+, Ca2+ and Mg2+ ions present at each stage in the process during the treatment of 1 m3/h of water intended for nutritional purposes, with a membrane surface area employed in the electrodialysis of 25.4 m2, are presented in the following table 1.

TABLE 1

| | 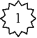 | 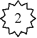 | 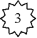 | 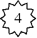 | 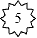 |
|---|---|---|---|---|---|
| Flow rate (m3/h) | 1 | 0.204 | 0.796 | 0.204 | 0.999 |
| Na+(mg/l) | 120 | 563 | 4.5 | 71 | 19 |
| K+(mg/l) | 10 | 46 | 0.4 | 4 | 1.2 |
| Ca2+(mg/l) | 20 | 94 | 0.8 | 60.4 | 13.1 |
| Mg2+(mg/l) | 10 | 47 | 0.5 | 35 | 7.6 |

The water yield is 100% apart from feeding the electrodialyzer (1% maximum).

It is found that the concentration of sodium cations has decreased by 84% and that the concentration of potassium cations has decreased by 88%. As regards the divalent cations, the loss of calcium cations is 34.5% and that of magnesium cations is 24%.

The combination of the reverse osmosis at standard pressure and of the electrodialysis made possible the preferential reduction in the content of monovalent cations in a water intended for nutritional purposes while not significantly modifying the content of divalent cations, ions having a proven health benefit. The water obtained had a controlled mineral content and is suitable for individuals who, for medical reasons, wish to restrict their consumption of sodium while retaining a good nutritional balance.

The water and calcium yields at the outlet of the process (5) as a function of the membrane surface areas employed in the electrodialysis (AED) are presented in table 2.

TABLE 2

| Ca2+ Yield (%) | Water Yield (%) | AED (m2) |
|---|---|---|
| 65 | 100 | 25.4 |
| 69 | 92.6 | 26 |
| 70 | 91 | 26.1 |
| 72.4 | 86.5 | 26.5 |
| 76 | 80.7 | 27 |
| 83.9 | 69.9 | 28 |
| 93.2 | 60 | 29 |

The sodium concentration at the outlet (5) is equal to 19 mg.l-1 in all cases. The process according to the present invention made possible to obtain a very good yield of water and of divalent cations. Furthermore, no regeneration may be necessary, in contrast to a treatment with ion-exchange resins.

We claim:

1. A process for depleting monovalent cations from water comprising
subjecting said water to reverse osmosis wherein retentate from said reverse osmosis has a higher ionic concentration than said water,
subjecting said retentate to electrodialysis, and
recovering water depleted in monovalent cations.

2. The process according to claim 1, wherein the permeate from the reverse osmosis is added to said water depleted in monovalent cations.

3. The process according to claim 1, wherein the yield of said water depleted in monovalent cations is about 100% and the yield of divalent cations is at least about 65%.

4. The process according to claim 1, wherein the water comprises about 3 g/l of total ions or less.

5. The process according claim 1, wherein the sodium content of said water ranges from about 20 mg/l to about 150 mg/l.

6. The process according to claim 1, wherein said water depleted in monovalent cations comprises less than about 20 mg/l of sodium.

7. The process according to claim 1, wherein the pressure of the reverse osmosis is less than about 10 MPa.

8. The process according to claim 7, wherein the pressure of the reverse osmosis ranges from about 0.2 MPa to about 5 MPa.
